(19) United States
(12) Patent Application Publication
(10) Pub. No.: US 2004/0224659 A1
(43) Pub. Date: Nov. 11, 2004

(54) Power saving method for mobile unit

(76) Inventor: Steven D. Cheng, San Diego, CA (US)

Correspondence Address: Cynthia L. Pillote, Snell & Wilmer L.L.P., One Arizona Center, 400 East Van Buren, Phoenix, AZ, 85004-2202, US

(21) Appl. No.: 10/434,661

(22) Filed: May 8, 2003

(51) Int. Cl. H04M 1/00

(52) U.S. Cl. 455/404.1; 455/574; 455/436

(57) ABSTRACT

The present invention provides a power saving method for a mobile unit in a wireless communication network. The wireless communication network includes a first base station and a second base station. The first base station transmits a first signal having a first signal level to the mobile unit via first broadcast control channel (BCCH). The second base station transmits a second signal having a second signal level to the mobile unit via a second BCCH. The first signal level is stronger than the second signal level. First, the present invention inputs an emergency telephone number. Then, the mobile unit connects with the first base station and disables a cell reselection process to save power.

### FIELD OF INVENTION

The present invention relates to a power saving method for a mobile unit and, more particularly, to a power saving method for a mobile unit, using GSM or related standards, for emergency calls.

### BACKGROUND OF THE INVENTION

There are many reasons for the mobile users to use the mobile phones to make an emergency 911, a.k.a. E911, call. The duration of E911 conversation varies case by case. In some scenarios, the conversation will be ended in minutes. In others, the conversation may last for days or weeks. For example, the report of a house on fire using E911 call may be short, but the call for help for the people who are buried under the rubble during the earthquake may last until either they are rescued or they become unable to use the phone to communicate. The latter scenario includes situations in which the mobile phone user can't use the mobile phone physically, such as when the user looses conscience, or the failure of handset, such as when the mobile phone battery dies.

The battery plays a major role in the handset functional availability. Based on some preliminary studies, for a handset low usage scenario, some batteries can last for 1 to 2 days without being charged, while others may last for a week or more. The more the mobile phone is being used, the shorter battery life it expected. As a result, it seems that current design of the handset products is not reliable means for people in extreme E911 scenarios such as the earthquake case mentioned above. Unfortunately, for people encountering this kind of situation, the mobile phone becomes their only hope to reach the rescue persons.

There are two different major approaches to maintain the battery life cycle: to recharge it or to reduce the power consumption. For recharge approach, the battery can be recharged through the power cable or through the solar energy system. For the power consumption issue, many different approaches have been introduced, and there are more new ideas expected to be unveiled in the coming future.

In GSM protocols, the use of Discontinuous Reception (DRX) mode is an example to eliminate the power consumption. DRX is a technique that allows the mobile phone to power down significant amounts of its internal circuitry for a high percentage of the time when the mobile unit is in the idle mode. The output power of digital phone is driven by the received signal strength from the RF channel it listens to. Unlike the power consumption design used in the digital mobile phone design, the conventional analog phone emits the constant output power despite the received signal strength. As a result, the digital mobile phones have incorporated the power saving feature into the design.

### SUMMARY OF THE INVENTION

The present invention provides a power saving method for mobile units to improve the current power saving feature inside the GSM mobile units. The present invention deals with the E911 cases while the users can't recharge the mobile unit and depends on the mobile unit as the only possible means to look for help over a long period of time. The present invention provides a power saving method for a mobile unit in a wireless communication network. The wireless communication network includes a first base station and a second base station. The first base station belongs to a first Public Land Mobile Network. The first base station transmits a first signal having a first signal level to the mobile unit via first broadcast control channel (BCCH). The second base station belongs to a second Public Land Mobile Network. The second base station transmits a second signal having a second signal level to the mobile unit via a second broadcast control channel. The first signal level is stronger than the second signal level. First, the present invention inputs an emergency telephone number. Then, the mobile unit connects with the first base station and disables a cell reselection process to save power.

### BRIEF DESCRIPTION OF THE DRAWINGS

FIG. 1 shows a schematic diagram of a wireless communication system,

FIG. 2 shows the flow chart of normal call operation; and

FIG. 3 shows a flow chart of the present invention.

### DETAILED DESCRIPTION

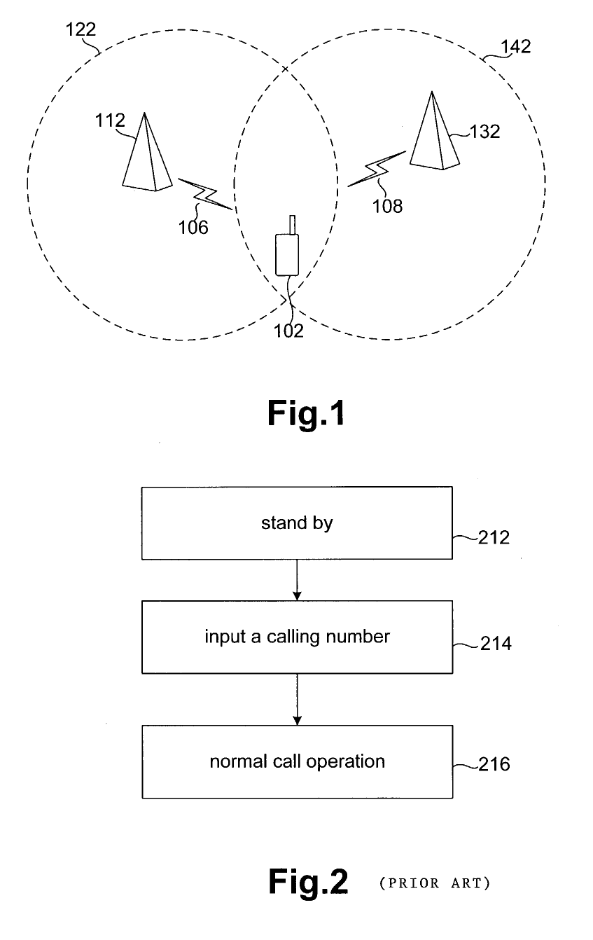

FIG. 1 shows a schematic diagram of a wireless communication system. The wireless communication system of the present invention is the Global System for Mobile Communication (GSM) including a first base station 112 and a second base station 132. The first base station 112 and the second base station 132 respectively correspond to a first cell 122 and a second cell 142. The first base station 112 and the second base station 132 respectively belong to different Public Land Mobile Networks (PLMN). A mobile unit 102 respectively receives a first signal and a second signal from the first base station 112 via a first Broadcast Control Channel (BCCH) 106 and from the second base station 132 via a second Broadcast Control Channel 108. The first signal has a first signal level. The second signal has a second signal level.

FIG. 2 shows the flow chart of normal call operation. In step 212, the mobile unit stands by. A user inputs a calling number in step 214. Then, the mobile unit, in step 216, proceeds as a normal call operation. In this normal call operation, the mobile unit implements a cell reselection process to make the cell change action done in a graceful way. This includes the following two major purposes: find a better base station from the neighbor cells to replace the current serving base station, and find a base station from the neighbor cells to replace the current serving base station whose path loss criteria is less than 0. The cell reselection algorithm is started when the mobile unit connects with a suitable base station. The mobile unit continues to perform this process in both transfer mode and idle mode.

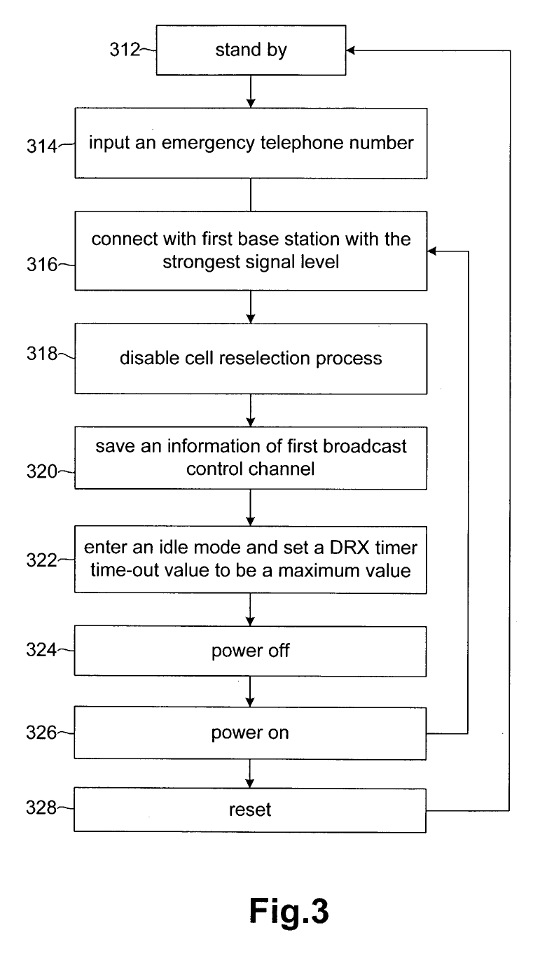

FIG. 3 shows a flow chart of the present invention. The present invention provides a power saving method for a mobile unit in a wireless communication network. In this embodiment the wireless communication network is a Global System for Mobile communication system (GSM). The wireless communication network includes a first base station and a second base station. The first base station transmits a first signal having a first signal level to the mobile unit via a first broadcast control channel. The second base station transmits a second signal having a second signal level to the mobile unit via a second broadcast control channel. The mobile unit selectively proceeds a cell reselection process to search for the second base station for switching to the second base station.

In step 312, the mobile unit stands by. Then a user inputs an emergency telephone number e.g. 911 in step 314. The mobile unit connects with a base station transmitting the strongest signal level in step 316.

The output emission power of the mobile unit is decided based on the received signal level. The stronger the received signal level is, the less output power will be emitted, and the less power will be consumed. As a consequence, if the mobile unit can connect with the base station transmitting the strongest signal, the mobile unit will have a longer battery life cycle. The present invention scans radio frequency (RF) channels in the system and monitors RF channels in the same time frame. The mobile unit takes the readings of received RF signal level on each channel, and calculates the average values. The average value is based on at least five measurement samples per RF carriers spread over 3 to 5 seconds. The measurement samples from the different RF carriers are spread evenly during this period. The mobile unit then searches for the first RF channel that is a BCCH with the strongest signal level. Since the first signal level is stronger than the second signal level in this embodiment, the mobile unit selects to connect with the first base station via the first broadcast control channel in step 316.

When connecting with the first base station in step 316, the mobile unit defaultly and selectively proceeds with a cell reselection process to search for the second base station for switching to the second base station. Since the user doesn't have the intention to move around, there is no need to use the cell reselection to look for a backup base station to substitute the current serving base station. Therefore, the mobile unit disables cell reselection process in step 318 to save power. Once the cell reselection process is disabled, the information of the first broadcast control channel will be stored into the non-volatile memory in step 320.

After step 320, the present invention further enters an idle mode and sets a DRX timer time-out value to be a maximum value in step 322. In the idle mode, the DRX feature of GSM allows users to get the E911 center's attention through the paging when the mobile unit eliminates unnecessary power consumption. According to GSM 04.60, the DRX Timer time-out value SPLIT_PG_CYCLE controls the occurrence of paging blocks on Common Control Channel (CCCH) or Packet Common Control Channel (PCCCH) belonging to the mobile unit in DRX mode. Thus, the longer the occurrence of paging blocks, the less the power will be consumed. According to the current GSM protocol, the DRX Timer time-out value is negotiable to 32. However, the maximum number in the domain is a much stronger number. Therefore, when the mobile unit enters the idle mode, the present invention extends the DRX Timer time-out value as long as possible.

In case the mobile unit powers off in step 324 and stay at the same place, the mobile unit is allowed to quickly connect with the first base station according to the information of first broadcast control channel when the mobile unit powers on in step 326. If the user resets the mobile unit in step 328, the mobile unit will return to step 312.

While this invention has been described with reference to an illustrative embodiment, this embodiment is not intended to be construed in a limiting sense. Various modifications of the illustrative embodiment, as well as other embodiments of the invention, will be apparent to persons skilled in the art upon reference to this description. It is therefore contemplated that the appended claims will cover any such modifications or embodiments as falling within the true scope of the invention.

I claim:

1. A power saving method for a mobile unit in a wireless communication network, said wireless communication network including a first base station and a second base station, said first base station transmitting a first signal having a first signal level to said mobile unit via a first broadcast control channel, said second base station transmitting a second signal having a second signal level to said mobile unit via a second broadcast control channel, said first signal level being stronger than said second signal level, said mobile unit selectively proceeding a cell reselection process to search for said second base station for switching to said second base station, comprising:
(a) inputting an emergency telephone number;
(b) connecting with said first base station; and
(c) disabling said cell reselection process to save power.

2. The method of claim 1, after step (c) further comprising:
(d) storing an information of said first broadcast control channel.

3. The method of claim 1, after step (c) further comprising:
(e) entering an idle mode; and
(f) setting a DRX timer time-out value to be a maximum value.

4. The method of claim 1, wherein said first signal level and said second signal level are measured by scanning radio frequency channels in said wireless communication system.

5. The method of claim 1, wherein said wireless communication system is a Global System for Mobile communication system (GSM).

6. A power saving method for a mobile unit in a wireless communication network, said wireless communication network including a first base station and a second base station, said first base station transmitting a first signal having a first signal level to said mobile unit via a first broadcast control channel, said second base station transmitting a second signal having a second signal level to said mobile unit via a second broadcast control channel, said first signal level being stronger than said second signal level, said mobile unit selectively proceeding a cell reselection process to search for said second base station for switching to said second base station, comprising:
(a) inputting an emergency telephone number;
(b) connecting with said first base station;
(c) disabling said cell reselection process;
(d) storing an information of said first broadcast control channel;
(e) entering an idle mode; and
(f) setting a DRX timer time-out value to be a maximum value.

7. The method of claim 6, wherein said first signal level and said second signal level are measured by scanning radio frequency channels in said wireless communication system.

8. The method of claim 6, wherein said wireless communication system is a Global System for Mobile communication system (GSM).
